(19) United States
(12) Patent Application Publication
(10) Pub. No.: US 2007/0054411 A1
(43) Pub. Date: Mar. 8, 2007

(54) Method and system for detecting heterogeneities in mixing

(75) Inventors: Harold M. Hastings, Garden City, NY (US); Sabrina G. Sobel, Farmingdale, NY (US); Carolyn B. Cammalleri, West Islip, NY (US)

Correspondence Address: HOFFMANN & BARON, LLP, 6900 JERICHO TURNPIKE, SYOSSET, NY, 11791, US

(73) Assignee: Hofstra University

(21) Appl. No.: 11/507,379

(22) Filed: Aug. 21, 2006

Related U.S. Application Data
(60) Provisional application No. 60/711,235, filed on Aug. 25, 2005.

(51) Int. Cl. G01N 21/00

(52) U.S. Cl. 436/164

(57) ABSTRACT

A method for detecting mixing heterogeneities is provided. The method includes subjecting components of a sensitive chemical reaction to mixing conditions while illuminating the medium sufficiently to observe regions of heterogeneity resulting from insufficient mixing. A system for detecting mixing homogeneities is also provided.

This application claims the benefit of U.S. Provisional Application No. 60/711,235 filed on Aug. 25, 2005, the disclosure of which is incorporated herein by reference.

This invention was made with Government support under grant numbers 0096692 and 0320865 awarded by the National Science Foundation. The Government has certain rights in this invention.

This invention relates to a method and system for detecting heterogeneities in mixing. More specifically, this invention relates to a method and system for detecting mixing heterogeneities in liquid phase reaction vessels.

### BACKGROUND OF THE INVENTION

Mixing heterogeneities in industrial reaction vessels can adversely affect product yield and product quality. Moreover, mixing is a complex process and not readily amenable to full mathematical and computer analyses.

Mixing heterogeneities can occur in a reaction vessel for many different reasons. For example, a mixing heterogeneity can occur due to the inability of the mechanical mixing device to physically generate enough mixing force on the reagents. This could occur, for example, if the reagents are very viscous. A mixing heterogeneity can also occur due to the shape of the vessel. Very often, these mixing heterogeneities can be ameliorated if identified.

Two experimental techniques to identify mixing heterogeneities involve the use of tracers in the solutions and structural light photographic techniques to obtain the tracer distribution in three dimensions. The tracers can be either very small suspended solid particles (“Particle Image Velocimetry” or PIV, See, www.dantecdynamics.com/piv/princip/) or fluorescent dyes (“Planar laser induced fluorescence” or PLIF, See, http://hanson.stanford.edu/research/PLIF/background.htm). Both techniques are limited in their sensitivity, ability to detect very small stagnation zones, and fluctuations in fronts between liquids being mixed.

Accordingly, a need exists for an improved method and system for detecting heterogeneities in mixing.

### SUMMARY OF THE INVENTION

In accordance with the present invention, a method and system is provided for detecting mixing heterogeneities in mixing vessels.

The method and system include subjecting components of a sensitive chemical reaction to mixing conditions while illuminating the reaction sufficiently to observe regions of heterogeneity which might result from insufficient mixing. In a preferred embodiment, a region of heterogeneity is manifest as a target or phase wave of oxidation, especially where the sensitive chemical reaction is one selected from a group consisting of the Belousov-Zhabotinsky (BZ) reaction and the chlorite-iodide-malonic acid (CIMA) reaction.

The method and system also includes illumination using, for example, at least one light source which projects a plane of light across the fluid medium. For example, the light source can be a laser. There can be a number of light sources to move the plane of light within the fluid medium. The regions of heterogeneity can be observed using a camera, especially a charge-coupled device (CCD) camera. In addition, a number of video cameras, preferably CCD video cameras can be used to photograph all points of heterogeneity within the fluid medium.

The system of the present invention includes a mixing vessel having a exterior and an interior, a mixer in the interior of the mixing vessel, components of a sensitive chemical reaction in the interior of the reaction vessel, at least one light source capable of illuminating the interior of the vessel, and at least one camera capable of photographing regions of heterogeneity resulting from insufficient mixing.

The use of sensitive chemical reactions can amplify mixing heterogeneities and, therefore, provides the advantage of more readily detecting mixing heterogeneities in a mixing vessel.

For a better understanding of the present invention, together with other and further objects, reference is made to the following descriptions, taken in conjunction with the accompanying drawings, and its scope will be pointed out in the appended claims.

### BRIEF DESCRIPTION OF THE DRAWINGS

Preferred embodiments of the invention have been chosen for purposes of illustration and description and are shown in the accompanying drawings wherein:

FIG. 1 is a schematic of the Belousov-Zhabotinsky (BZ) reaction;

FIG. 2 is a perspective view of an industrial mixing vessel with a structured light source and camera for detecting mixing heterogeneities;

FIG. 3 is a perspective view of an industrial mixing vessel with a photometry device for detecting mixing heterogeneities;

FIGS. 4(a)-(c) show the development of phase waves in a BZ reaction using red LED illumination;

FIGS. 4(d)-(f) show a 3D simulation of the development of phase waves shown in FIGS. 4(a)-(c);

FIGS. 5(a)-(c) show the development of phase waves in a BZ reaction using blue LED illumination;

FIGS. 5(d)-(f) show a 3D simulation of the development of phase waves shown in FIGS. 5(a)-(c); and

FIG. 6 shows a computer generated model simulating ideal mixing at the start followed by micro-scale concentration fluctuations due to diffusion in an unstirred reaction mixture.

### DETAILED DESCRIPTION OF THE INVENTION

The present invention provides a method and system for detecting heterogeneities in mixing. The method and system includes subjecting a fluid medium containing components of a sensitive chemical reaction to mixing conditions while illuminating the medium sufficiently to observe regions of heterogeneity resulting from insufficient mixing.

Mixing Heterogeneity

A mixing heterogeneity, as defined herein, is a point within in a mixing vessel where a reaction condition, e.g., reagent concentration, temperature, catalyst concentration, etc., is not the same throughout the mixing vessel within which the reaction is taking place. Such variable reaction conditions within the mixing vessel do not occur when the reagents in the reaction vessel are mixed completely and, therefore, are indicative of a mixing heterogeneity. The present invention permits the spatiotemporal (space and time) identification of the mixing heterogeneity within the mixing vessel.

Sensitive Chemical Reaction

The method of the invention includes the utilization of a sensitive chemical reaction to identify mixing heterogeneities. A “sensitive chemical reaction,” as defined herein, is a fluid chemical reaction which undergoes a particular visible change in situ within the mixing vessel in response to a variable reaction condition for a sufficient period of time to be observed. In addition, the sensitive chemical reaction does not undergo the particular visible change when the variable reaction conditions are not present, indicating complete mixing and the absence of mixing heterogeneity.

Preferably, the sensitive chemical reaction undergoes the visible change in response to even a small variable reaction condition. For example, the sensitive chemical reaction can auto-catalytically increase the concentration of one or more components, thus amplifying pre-existing heterogeneities. In this way, the sensitive chemical reaction can be used to amplify even small variable reaction conditions caused by mixing heterogeneity.

In a preferred embodiment, the sensitive chemical reaction is one that includes the following components:
1. a coloring catalyst component that auto-catalytically increases its concentration, which, in turn, amplifies heterogeneities;
2. a component that promotes the reactivity of the auto-catalytic component,
3. a component that acts as an inhibitor;
4. a component that acts to both regenerate the catalyst and the inhibitor; and
5. a component that can act as a visual indicator of the phase of the reaction.
   These components cause the reaction to demonstrate behavior of oscillation between two phases. One component can have multiple roles in the sensitive chemical reaction.

Sensitive chemical reactions as defined herein are known in the art. See, for example, Segués, F. and Epstein, I. R., (2003) ‘Nonlinear Chemical Dynamics’ J. Chem. Soc. Dalton Trans. 1201-1217, incorporated herein by reference.

One example of a sensitive chemical reaction includes the Belousov-Zhabotinsky (BZ) reaction. The BZ reaction is an oscillatory reaction, which displays an oscillating pattern as a whole between red/reduced and blue/oxidized states.

The BZ reaction is a known reaction and is described in B. P. Belousov, Sbornick Referatov po Radiatsionni Meditsine (Medgiz, Moscow, 1958), pp 145-160; A. M. Zhabotinsky, Biofizika 9, 306 (1964) R. J. Field and M. Burger (eds), Oscillations and Traveling Waves in Chemical Systems (Wiley-Interscience, New York, 1985); B. Z. Shakashiri, Chemical Demonstrations, Vol. 2. (Univ. of Wisconsin Pr, Madison, Wis., 1985), pp. 298-300; S. K. Scott, Oscillations, Waves, and Chaos in Chemical Kinetics, Oxford Chemistry Primers 18 (Oxford University Press, New York, 1994); R. J. Field, F. Körös, and R. M. Noyes, J. Amer. Chem. Soc. 94, 8649-8664 (1972); R. J. Field, and R. M. Noyes, Oscillations in Chemical Systems. IV. Limit Cycle Behavior in a Model of a Real Chemical Reaction, J. Chem. Phys. 60, 1877-1884 (1974); and in Scott, S. K. 1994. Oscillations, Waves, and Chaos in Chemical Kinetics, Oxford Chemistry Primers 18. Oxford Univ. Pr., Oxford, UK and N.Y.; all of which are incorporated herein by reference.

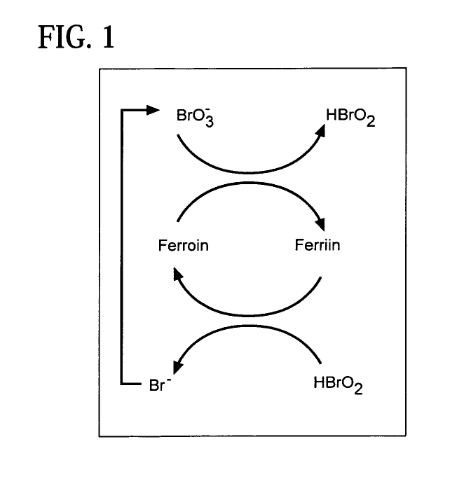

A BZ reaction can be prepared by mixing 0.2 M malonic acid, 0.3 M sodium bromate, 0.3 M sulfuric acid, and 0.005 M ferroin. The BZ reaction is complex, and involves more than 40 elementary reactions. However, the basic behavior of the BZ reaction can be understood by the scheme shown in FIG. 1.

In FIG. 1, HBrO₂=bromous acid; Br⁻=bromide ion; and ferriin is an oxidized form of ferroin. Bromous acid undergoes an autocatalytic reaction. Its amount increases exponentially with time, like an explosion process. The other result of the process is the production of ferriin oxidized from ferroin. The production of ferriin from ferroin is seen as a change in color from red to blue. When the amount of ferriin becomes large, ferriin (blue) starts to change back slowly to ferroin (red) while bromide ions are produced. Bromide is an effective inhibitor of the autocatalytic reaction. Bromide slows the production of bromous acid, which reduces the amount of bromous acid. With time, bromide ions are consumed, and the system repeats.

Other chemical reactions have similar properties, and can therefore be utilized as a sensitive chemical reaction in the invention. For example, the Chlorite-Iodide-Malonic-Acid (CIMA) reaction is another oscillating pattern reaction similar to the BZ reaction. The CIMA reaction is a known reaction, and is described in P. De Kepper, I R. Epstein, K. Kustin, and M. Orban, J. Phys. Chem. 86, 170 (1982); M. Orban, C. Dateo, C., P. De Kepper, and I. R. Epstein. J. Am. Chem. Soc. 104, 5911(1982); P. DeKepper, J. Boissonade, and I R. Epstein, J Phys. Chem. 94 6525 (1990); all of which are incorporated herein by reference. Similar to the BZ reaction, the CIMA reaction exhibits periodic oscillation, bistability between steady states, chemical waves, and pattern formation.

The term sensitive chemical reaction as defined herein is also intended to include variations in the standard BZ and CIMA reaction recipes, as is known in the art. See, for example, Segués, F. and Epstein, I. R., (2003), “Nonlinear Chemical Dynamics,” J. Chem. Soc. Dalton, Trans., 1201-1217, incorporated herein by reference.

It has previously been demonstrated how small variations in reaction conditions can drive target nucleation and how target nucleation, as opposed to oscillations, might arise from such variations. See, H. M. Hastings, R. I. Field and S. G. Sobel, J. Chem. Phys. 119, 3291 (2003), incorporated herein by reference. In addition, the inventors have observed statistically significant non-random target wave formation in the form of spatio-temporal correlations, even in relatively well mixed BZ systems, although this effect disappeared under conditions of complete mixing. See, Hastings et al., “Spatiotemporal Clustering and Temporal Order in the Excitable BZ Reaction”, J. Chem. Phys., p. 123 (2005), incorporated herein by reference.

In a preferred embodiment, variable reaction conditions due to mixing heterogeneities are translated into spatio-temporal patterns called target waves or phase waves, whose local velocity corresponds to the degree of the variable reaction conditions present due to mixing heterogeneity. If the reactants are poorly mixed, target waves will be observed. If the reactants are well mixed, but the solution still contains heterogeneities, phase waves will appear.

Bulk Behavior Indicates Complete Mixing

Under conditions of complete mixing, there are no variable reaction conditions. In other words, the reaction conditions are virtually the same throughout the mixing vessel. Thus, there are virtually no mixing heterogeneities.

In the absence of mixing heterogeneity, in a continuously stirred batch reactor, one would see nearly homogeneous or “bulk” behavior in the sensitive chemical reaction. The homogenous behavior would appear uniformly as an oscillation of the whole solution within the mixing vessel. In the BZ reaction, the homogeneous behavior would appear to flash from red to blue all at once throughout the reaction medium, and then return to red throughout the reaction medium.

Phase Waves Indicate Incomplete Mixing

If the reactants are well mixed, but the solution still contains heterogeneities, phase waves will appear in the mixing vessel.

Phase waves appear in two forms. One form is a phase area, which is a part of the medium that is in a different state than the medium immediately surrounding it. Phase areas appear as blobs of color that alternate. In the case of the BZ reaction, areas of blue appear in a surrounding red medium and, alternately, areas of red in a blue surrounding medium, in an apparently coordinated fashion.

The second form of phase wave is a clocking wave. Clocking waves are large phase waves that move from one area of the solution to another area of solution. The heterogeneity of solution states can be thought of as occurring somewhat smoothly on a continuum from the originating area to the terminating area. In the BZ reaction, a clocking wave would appear as a blue wave through a red medium.

Target Waves Indicate Poor Mixing

If the reactants are poorly mixed, target waves will appear in the mixing vessel. Target waves are waves that originate at one point and move repeatedly outward, similar to ripples flowing out from where a pebble is dropped in water. These “ripples” form a pattern of outwardly expanding waves.

In the BZ reaction, target waves appear as waves of oxidation of the catalyst/indicator ferroin/ferriin, which appears red in the reduced (ferroin) form and blue in the oxidized (ferriin) form. These waves appear as blue/oxidized (high ferriin, low ferroin) target patterns moving outwards from nucleating centers in a red/reduced medium (low ferroin, high ferroin).

Target waves will form in a well mixed reaction after the reaction is permitted to sit unstirred. This formation of target waves after the cessation of mixing reflects the presence of microscopic heterogeneities that are being amplified by the sensitive chemical reaction.

Differences between target (trigger) waves and phase waves are described in Reusser, E. J. and Field, R. J., “The transition from phase waves to trigger waves in a model of the Zhabotinskii reaction,” J. Am. Chem. Soc., 101(5), 1063-1071 (1979), incorporated herein by reference.

Thus, the presence of target wave and phase wave nucleation in the ferriin-catalyzed BZ reaction depends upon mixing heterogeneities. The existence of and amplification of mixing heterogeneities appears to be the cause of spatiotemporal clustering of target centers. Without being bound by theory, it is believed that mixing heterogeneities may cause spatial heterogeneity in the rate of bromination of malonic acid to form bromo-malonic acid.

Use of Sensitive Chemical Reaction to Detect Mixing Heterogeneity

In the method of the invention, the sensitive chemical reaction is used to detect a mixing heterogeneity in a mixing vessel. The method of the invention includes subjecting a fluid medium, which includes the components of a sensitive chemical reaction, to mixing conditions. Preferably, the mixing conditions will occur in a mixing vessel to be tested.

The mixing vessel can be any vessel used to mix reactants. For example, the mixing vessel can be a bulk reactor or flow-through reactor. A bulk reactor is preferred, since the activity of the phase and target waves are more predictable. Nevertheless, even in a flow-through reactor, mixing heterogeneities can be identified by spatio-temporal heterogeneity in phase and target wave activity.

While the components are being mixed, the components are illuminated to observe regions of heterogeneity resulting from insufficient mixing. As stated above, when the components of a sensitive chemical reaction are subjected to conditions of ideal or complete mixing, a steady state is maintained in which the normal oscillation of the reaction takes place uniformly in bulk. The presence of phase waves will indicate substantial, but still incomplete, mixing. The presence of target waves of oxidation indicates poor mixing.

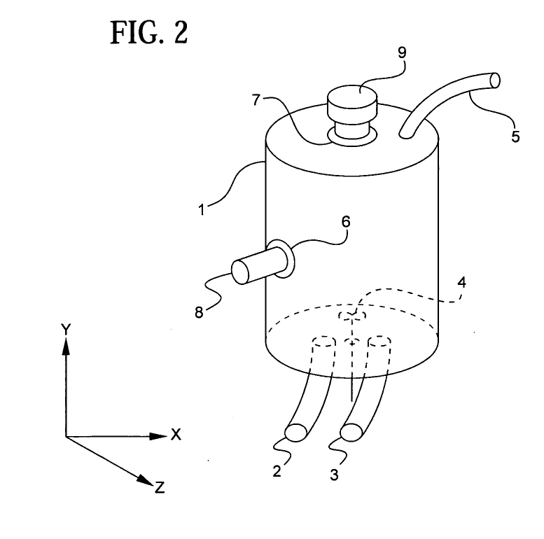

FIG. 2 illustrates an industrial mixing vessel 1, with inputs 2,3 for reagents to enter the vessel. Mixing vessel 1 also includes a mixing device 4, such as a propeller, and an output 5 for reaction products to leave the vessel. The mixing vessel 1 as shown in FIG. 2 also contains a plurality of ports with transparent windows 6, 7. Such windows typically exist as porthole-type windows on the walls of a mixing vessel, or a narrow window spanning the height of the mixing vessel. If such windows do not exist on the mixing vessel, the mixing vessel can be retrofitted to include such windows by known means.

A light source 8 is shown attached to window 6, and a camera 9 is shown attached to window 7. In a preferred embodiment, the light source is a structured light source. Structured light is the projection of a light pattern at a known angle onto an object. This technique is known in the art and can be useful for imaging and acquiring dimensional information. The light pattern most often used is generated by fanning out a light beam into a sheet of light. The light source is preferably a laser sheet light source designed to illuminate in an essentially planar direction with a very small thickness.

In a preferred embodiment, the camera is a CCD camera. CCD is an abbreviation for charge-coupled device. The CCD camera includes a CCD sensor. A CCD sensor is a light sensitive semiconductor device which converts light particles (photons) into an electrical charge (electrons). Such cameras are commercially available. A sufficient number of light sources and cameras are provided in order to illuminate and photograph all portions of the interior of the reaction vessel 1, as is known to those skilled in the art.

Components of a sensitive chemical reaction are added to the mixing vessel 1 through inputs 2, 3. The components of the sensitive chemical reaction are then mixed using mixing device 4. Light source 8 is used to illuminate the inside of reaction vessel 1 to enable visualization of any target or phase waves of oxidation. Such target or phase waves indicate areas of mixing heterogeneities due to inadequate mixing.

For example, the light source is preferably a laser sheet light source designed to illuminate in an essentially planar direction with very small thickness. If, for example, a laser sheet is used to sweep planes z=z₁, z=z₂, z=z₃, . . . , illuminating in each case a thin region (Δz) at different heights within the vessel bounded by zᵢ±Δz, and the camera is located on the z-axis, then for each zᵢ the camera will record an image of regions bounded by zᵢ±Δz.

3D data may be reconstructed using x and y coordinates from camera images and z coordinates from the location of the illuminate plane, with resolution limited by the camera resolution in the x and y directions and by Δz in the z direction.

If desired, one could also sweep the illuminated planes through 3D space by rotation instead of translation, in which case the z-coordinate would be a function of both the index of the plane and the x and y coordinates. If a plurality of cameras are used, for example, one at the top of the vessel and one at the bottom; and a plurality of light sources are located, for example, at portholes on the sides of the vessel, then one could obtain 3D imaging of the whole interior of the vessel. With knowledge of the relevant camera and structured light geometry, the 3D location of any mixing heterogeneities within the mixing vessel can be located by observing a target or phase wave in the sensitive chemical reaction within the mixing vessel.

The technology involved in utilizing structured light and CCD cameras for imaging and acquiring dimensional information is well known in the art and commercially available. See, for example, www.stockeryale.com/i/lasers/structured_light.htm.

The sensitive chemical reaction can be used to test the mixing vessel for proper mixing before the reaction vessel is used for its ultimate commercial or industrial application. In addition, after the mixing vessel has already commenced its commercial or industrial use, if there are concerns about its mixing ability, the mixing vessel can be pulled off line and tested using the sensitive chemical reaction. This test can be used intermittently to ensure that the mixing vessel is mixing adequately.

In a preferred embodiment, the sensitive chemical reaction is designed to emulate the commercial or industrial reaction to be mixed in the mixing vessel. For example, the flow rates of the sensitive reaction chemical components entering the mixing vessel should be as close as possible to the flow rates of the components used in commercial or industrial application. In addition, the amounts of the sensitive chemical reaction components should be the same as that for the commercial or industrial reaction to be conducted in the mixing vessel.

Viscosity can affect mixing in a mixing vessel. Thus, in another preferred embodiment, additives can be used in the sensitive chemical reaction to emulate as close as possible the viscosity of the commercial or industrial reaction to be conducted in the mixing vessel. Such additives should not interfere with the reduction/oxidation reactions occurring in the sensitive chemical reaction. Suitable additives that can alter the viscosity of the components of the sensitive chemical reaction are known in the art and include, but are not limited to, agarose, hydroxyethyl cellulose, etc.

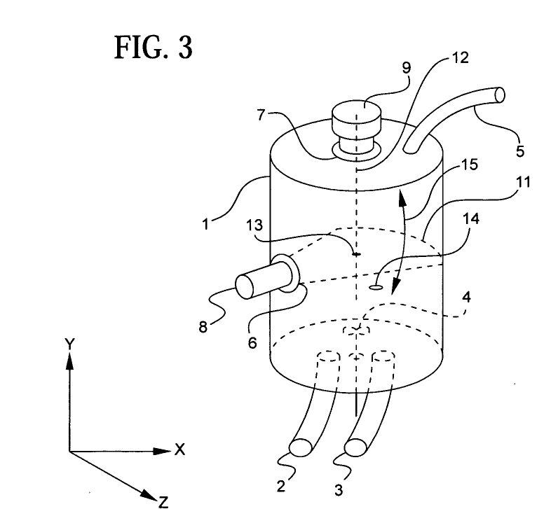

FIG. 3 illustrates an industrial mixing vessel 1, with two inputs 2, 3 for reagents to enter the vessel, a mixing device 4, and an output 5 for reaction products to leave the vessel. The vessel also contains ports with transparent windows 6, 7.

FIG. 3 also illustrates a plane of light 11 produced by a structure light source 8, and a ray 12 to the CCD camera 9. Ray 12 is a point in the plane of light that enters the camera though its lens. The ray 12 and plane 11 intersect at a unique point 13. A sufficient number of light sources are provided to illuminate all points 13 within the mixing vessel 1. Preferably, the light sources have mobility, so as to be able to move the planes 11 (the direction is shown by arrow 15), and reduce the number of light sources needed to illuminate the entire vessel. Such light sources are commercially available.

In addition, in a preferred embodiment, mixing vessel 1 is equipped with video cameras (not shown). In a preferred embodiment, the video cameras are CCD video cameras. It is preferred that mixing vessel 1 be equipped with a sufficient number of video cameras to photograph all points 13 in the interior of the mixing vessel. It may also be necessary to sweep the cameras to photograph the full interior of the mixing vessel. Such video cameras are commercially available, for example, Canon EOS-20D. By illuminating and photographing the entire interior of the mixing vessel, all points or small regions of mixing heterogeneity 14 can be identified. As discussed above, such regions of mixing heterogeneity will visually appear as colored target waves or phase waves of oxidation within the fluid medium.

In another embodiment, measurement of the spatio-temporal distribution of phase areas or target wave centers can lead to a statistical evaluation of the degree of heterogeneity of solution in a vessel. The space within a mixing vessel can be divided into theoretical quadrants which are photographed over time. The location and frequency of the appearance of colored phase areas and target wave centers can then be measured.

The number of phase wave or target wave centers that appear throughout the mixing vessel can be correlated to the degree of mixing heterogeneities and their location. Phase waves will progress from a region more advanced in the progress of the reaction to a region less advanced. If targets form, then targets will begin first in areas where the progress of the reaction is most advanced.

### EXAMPLE 1

This example demonstrates the formation of phase waves due to mixing heterogeneities. A 3D simulation of the phase waves were then generated.

The auto-oscillatory BZ reaction mixture was prepared as set forth in H. M Hastings, et al., Chem. Phys., p. 123 (2005). The reaction mixture is based upon the Shakashiri formula (B. Z. Shakashiri, Chemical Demonstrations, Vol. 2. (Univ. of Wisconsin Pr, Madison, Wis., 1985), pp. 298-300), except for the use of a 0.40 M potassium bromate stock solution. Nanopure water was used throughout.

Ferroin was prepared from ferrous sulfate (Cenco) and 1,10-phenanthroline (Aldrich, 99%). The following stock solutions were then prepared: Sulfuric acid: 6.0 M, malonic acid: 0.50, potassium bromide: 0.5 M, potassium bromate: 0.40 M, and ferroin: 0.0121 M.

The following reagents were added to a 90 mm diameter plastic Petri dish: Sulfuric acid (6.0 M, 0.60 ml), malonic acid (0.50 M, 2.50 ml), potassium bromide (0.5 M, 1.0 ml), potassium bromate (0.40 M, 7.5 ml) and ferroin (0.0121 M, 0.50 ml) were combined in a 90 mm diameter plastic Petri dish.

The Petri dishes were then swirled for 10 seconds to mix the reactants. The Petri dishes were then permitted to sit for approximately three minutes to allow mixing heterogeneities to form. The Petri dishes were illuminated from underneath with a red LED. Photographs of the Petri dishes were then taken in 1 minute intervals with a Nikon Coolpix 5700 camera.

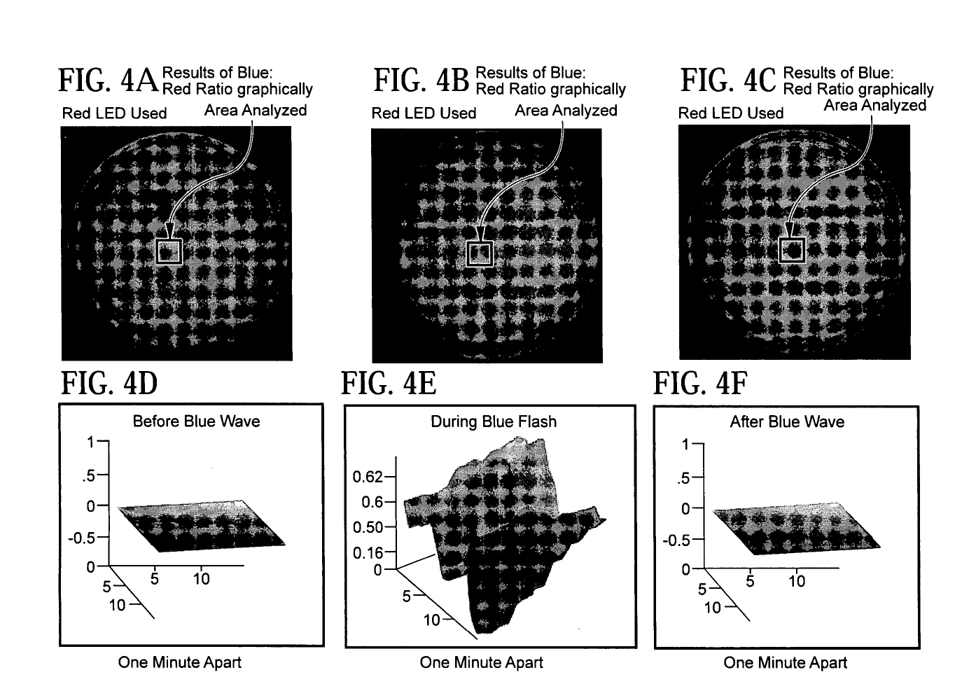

The results are shown in FIGS. 4(a)-(c), in which the BZ reaction mixture is illuminated with a red LED array. FIG. 4(a) shows the BZ mixture in the red reduced state 1 minute before a wave of activity. FIG. 4(b) shows the BZ mixture during phase wave activity as mixing heterogeneities enter the system. FIG. 4(c) shows a return to the red reduced state of the BZ mixture 1 minute after a wave of activity.

Thus, FIGS. 4(a)-(c) depict the formation of phase waves as a result of the formation of mixing heterogeneities.

3D computer simulations of what is depicted in FIGS. 4(a)-(c) were then created. To create the simulation, each digital photograph was opened in Adobe Photoshop and cropped to include only the area to be analyzed (see black box in photographs). A computer program extracted the raw data from the cropped digital photograph as a matrix of data including (x, y, red intensity, green intensity, blue intensity, luminosity). Each pixel has an (x,y) coordinate. The file created by the extraction program was opened using Microsoft Excel. The values of interest, such as red color intensity, were plotted as a topographical map as a function of (x,y) coordinates. In this way, quantitative data was generated from the digital photographs for more detailed analysis.

FIGS. 4(d)-(f) show a 3D computer simulation of what is depicted in FIGS. 4(a)-(c), respectively. More specifically, FIG. 4(d) shows a plot of red intensity values as a function of (x,y) coordinates for the boxed portion of FIG. 4(a). FIG. 4(e) shows a plot of red intensity values as a function of (x,y) coordinates for the boxed portion of FIG. 4(b). FIG. 4(f) shows a plot of red intensity values as a function of (x,y) coordinates for the boxed portion of FIG. 4(c).

Therefore, based upon the foregoing, wave activity can be quantitatively analyzed over time and three dimensional space.

### EXAMPLE 2

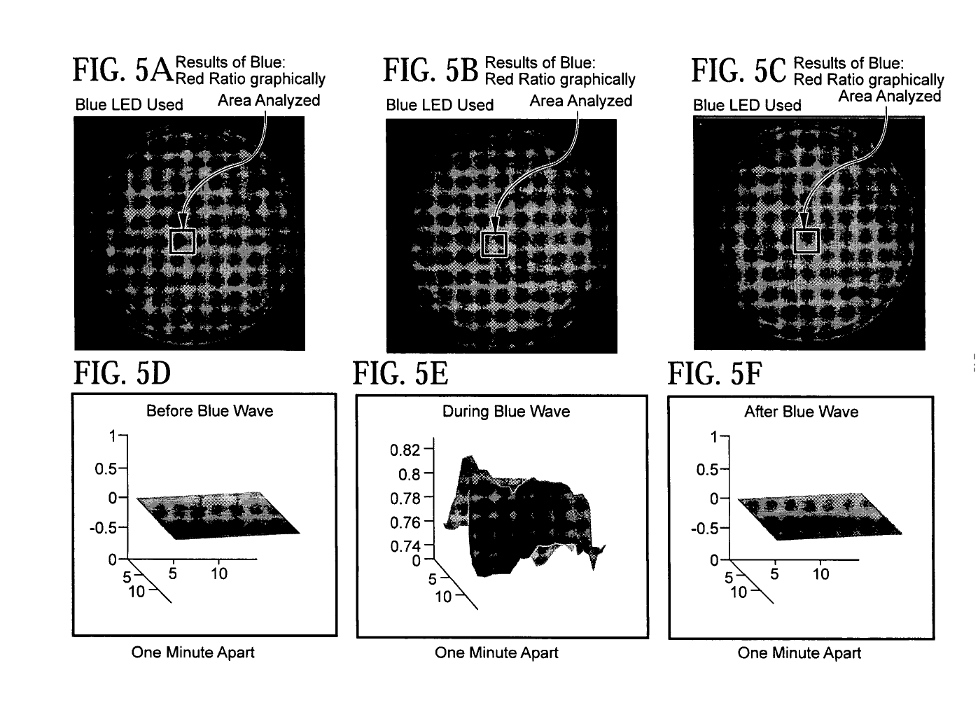

The same experiment was conducted as set forth in Example 1, except a blue LED light was used for illumination. The results are shown in FIGS. 5(a)-(c). FIG. 5(a) shows the BZ mixture 1 minute before a wave of activity. FIG. 5(b) shows the BZ mixture during a wave of activity. FIG. 5(c) shows the BZ mixture 1 minute after a wave of activity.

FIGS. 5(d)-(f) show a 3D computer simulation of what is depicted in FIGS. 5(a)-(c), respectively. More specifically, FIG. 5(d) shows a plot of red intensity values as a function of (x,y) coordinates for the boxed portion of FIG. 5(a). FIG. 5(e) shows a plot of red intensity values as a function of (x,y) coordinates for the boxed portion of FIG. 5(b). FIG. 5(f) shows a plot of red intensity values as a function of (x,y) coordinates for the boxed portion of FIG. 5(c).

Thus, FIG. 5 again shows how wave activity can be quantitatively analyzed over time and space.

### EXAMPLE 3

A 2D computer model was prepared based upon an extended Oregonator model as described in (H. M. Hastings, R. J. Field, and S. G. Sobel, J. Chem. Phys. 119 3291 (2003); Hastings et al., “Spatiotemporal Clustering and Temporal Order in the Excitable BZ Reaction”, J. Chem. Phys., (2005); and Sobel, S. G.; Hastings, H. M.; Field, R. J., “Oxidation State of BZ Reaction Mixtures,” J. Phys. Chem. A.; (Letter), 110(1):5-7 (2006). The model simulated ideal mixing at the start followed by micro-scale concentration fluctuations due to diffusion in an unstirred reaction mixture.

The following modified Oregonator model was used:
dx/dt=k₃[BrO₃⁻][H⁺]²y−k₂[H⁺]xy+k₅[BrO₃⁻][H⁺]x−k₄x² (1)
dy/dt=−k₃[BrO₃⁻][H⁺]²y−k₂[H⁺]xy+(f/2)k_{c}[MA]z+0.0002 df/dt (2)
dz/dt=2k₅[BrO₃⁻][H⁺]x−k_{c}[MA]z (3)
df/dt=k_{f}(f₂₈ −f), (4)
Here x=[bromous acid], y=[Br⁻] and z=[ferriin]. MA=malonic acid.

The original Oregonator (R. J. Field, E. Körös, and R. M. Noyes, J. Amer. Chem. Soc. 94, 8649-8664 (1972); R. J. Field and R. M. Noyes, J. Chem. Phys. 60, 1877-1884 (1974)) consists of the first three equations, without the last term 0.0002 df/dt in the second equation. As in H. M. Hastings, R. J. Field, and S. G. Sobel, J. Chem. Phys. 119, 3291 (2003), the fourth equation represents the temporal evolution of f arising from bromination of MA to for BrMA. The last term in the second equation, namely 0.0002 df/dt, represents bromide release from this process in a qualitative way. This was included included to keep the system in the observed high bromide, low ferriin, red state from time 0 through target formation as blue (high ferriin) nucleation sites in a red (low ferriin) background.

Oregonator parameters were assigned standard values, c.f. S. K. Scott, Oscillations, Waves, and Chaos in Chemical Kinetics, Oxford Chemistry Primers 18 (Oxford University Press, New York, 1994). Other parameter values included [H⁺]=0.316 M, corresponding to [H₂SO₄]=0.3 M; [BrO₃⁻]=0.25 M, as in experimental protocol, [MA]=0.1 M; k_{f}=10⁻³ s⁻¹ (similar to [12]); f₂₈ =0.7 (H. M. Hastings, R. J. Field, and S. G. Sobel, J. Chem. Phys. 119, 3291 (2003)).

The simulation was run as an ordinary differential equation with Euler method, Δt=5×10⁻⁴ s, as f increased from the initial value 0 through f=0.4, with initial concentrations x=0, y=10⁻³ M, and z=0. At the end, x=3.3187×10⁻³ M, y=1.399775×10⁻⁶ M, and z=0.0220229 M. This step captures the behavior of an ideally stirred system.

Random diffusion was then added (replace diffusion of N molecules by a sample from a normal distribution of mean N and variance N) to capture thermal fluctuations in a stochastic partial differential equation model: the Langevin approach. This equation was integrated with the Euler method, Δs=50 μm and Δt=5×10⁻⁴ s on a 200×200 lattice (10 mm²) with periodic boundary conditions model, starting with the following values from step 3: f=0.4, x=3.3187×10⁻³ M, y=1.399775×10⁻⁶ M, and z=0.0220229 M. The standard value for the diffusion constant D=2×10³ μm²s⁻¹ for x, y, and z was used. This step captures the dynamics of an unstirred reaction in a Petri dish.

A sequence of visual representations were produced at 1 s intervals representing x=[bromous acid] as the red color intensity (0=no color), and z=[ferriin] as the blue color intensity.

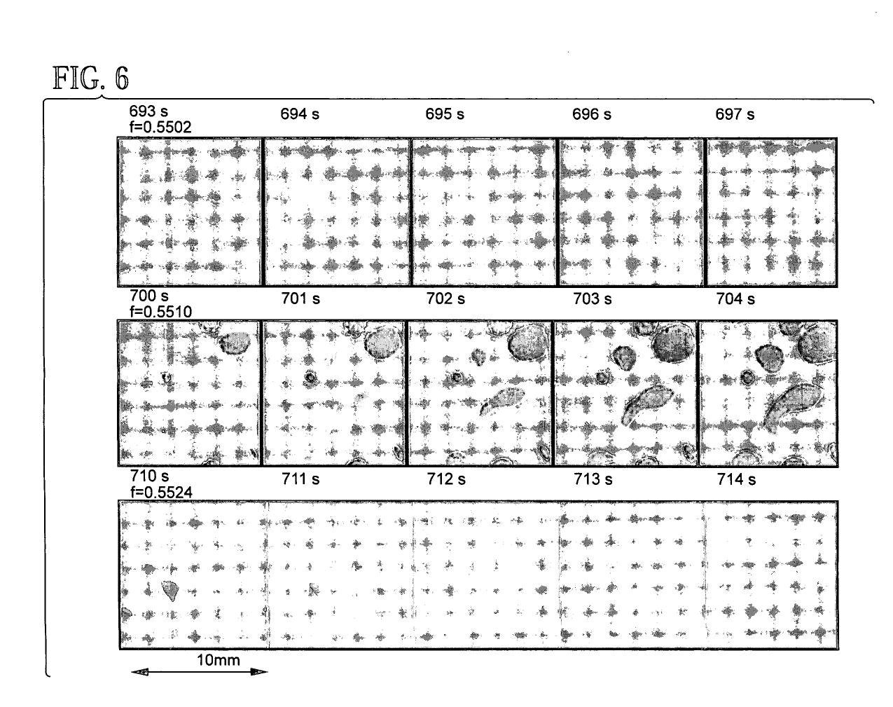

The results are shown in FIG. 6, which is an expanded version of FIG. 2D originally published in Hastings et al., “Spatiotemporal Clustering and Temporal Order in the Excitable BZ Reaction”, J. Chem. Phys., (2005). FIG. 6 shows the temporal evolution of the computer simulation of the BZ reaction using the methodology and format described. At the beginning of the simulation (693 to 697 seconds), there is perfect mixing and no targets areas are observed in a pink background. As mixing heterogeneities begin to develop after mixing is stopped (700 to 704 seconds), target areas develop very quickly, observed as blue blobs of color in the pink background. Over additional time with the reaction unstirred (710 to 714 seconds), the reaction progresses to the blue (oxidized) state everywhere.

Therefore, the presence of mixing heterogeneities in the BZ reaction produces the observed spatiotemporal clustering of target centers.

Thus, while there have been described what are presently believed to be the preferred embodiments of the invention, those skilled in the art will realize that changes and modifications can be made thereto without departing from the spirit of the invention, and it is intended to claim all such changes and modifications which fall within the true scope of the invention.

What is claimed is:

1. A method for detecting mixing heterogeneities in a mixing vessel, said method comprising:
subjecting components of a sensitive chemical reaction to mixing conditions in the mixing vessel, and
illuminating said components sufficiently to observe in three dimensions regions of heterogeneity resulting from insufficient mixing within said mixing vessel.

2. A method according to claim 1, wherein said region of heterogeneity is manifest as a target wave or phase wave of oxidation.

3. A method according to claim 2, wherein said target wave indicates a higher degree of heterogeneity than said phase wave.

4. A method according to claim 1, wherein said sensitive chemical reaction is a reaction selected from the group consisting of a Belousov-Zhabotinsky (BZ) reaction and a chlorite-iodide-malonic acid (CIMA) reaction.

5. A method according to claim 1, wherein said illuminating is carried out using at least one light source.

6. A method according to claim 5, wherein said illuminating comprises projecting a plane of light across said reactants.

7. A method according to claim 6, wherein said light source is a laser.

8. A method according to claim 6, wherein said illuminating is carried out by a sufficient number of light sources to move said plane of light within said components.

9. A method according to claim 1, wherein said regions of heterogeneity are observed using a camera.

10. A method according to claim 9, wherein said camera is a CCD camera.

11. A method according to claim 9, wherein said regions of heterogeneity are observed using a sufficient number of video cameras to photograph all points within said components.

12. A method according to claim 1, wherein said mixing vessel is an industrial batch reactor.

13. A system for detecting mixing homogeneities in a mixing vessel, said system comprising:
a mixing vessel having an exterior and an interior;
a mixer in the interior of said mixing vessel;
components of a sensitive chemical reaction in the interior of said mixing vessel capable of being subjected to mixing forces imposed by said mixer;
at least one light source capable of illuminating the interior of said mixing vessel; and
at least one camera capable of photographing regions of heterogeneity resulting from insufficient mixing.

14. A system according to claim 13, wherein said region of heterogeneity is manifest as a target wave or phase wave of oxidation.

15. A system according to claim 14, wherein said target wave indicates a higher degree of heterogeneity than said phase wave.

16. A system according to claim 13, wherein said light source is a laser.

17. A system according to claim 13, further comprising a sufficient number of light sources to selectively project a plane of light in substantially all portions of the interior of said mixing vessel.

18. A system according to claim 17, further comprising a sufficient number of video cameras to selectively photograph all portions of the interior of said mixing vessel.

19. A system according to claim 13, wherein said camera is a CCD camera.

20. A system according to claim 13, wherein said mixing vessel is an industrial batch reactor.
